(19) United States
(12) Patent Application Publication
(10) Pub. No.: US 2012/0168285 A1
(43) Pub. Date: Jul. 5, 2012

(54) LIGHTWEIGHT REINFORCED CONVEYOR BELT STRUCTURE

(75) Inventors: John E. Holland, Bailey, NC (US); Connie W. Holland, Bailey, NC (US); Daniel M. Nathan, Wendell, NC (US); Huy X. Nguyen, Midlothian, VA (US); Elizabeth S. Parrish, Blackstone, VA (US)

(73) Assignees: HONEYWELL INTERNATIONAL INC., Morristown, NJ (US); JHRG, LLC, Spring Hope, NC (US)

(21) Appl. No.: 12/984,709

(22) Filed: Jan. 5, 2011

(51) Int. Cl. B65G 15/34; B65G 15/28

(52) U.S. Cl. 198/847; 198/832

(57) ABSTRACT

Conveyor belts formed of a composite fabric structure. The fabric structure has a base reinforcing layer made of a network that includes high tenacity fibers. The composite fabric structure also includes a surface layer formed of rubber. The base layer and the surface layer are bonded together, preferably through the use of a bonding layer.

### BACKGROUND OF THE INVENTION

1. Field of the Invention

This invention relates to conveyor belt structures which are light in weigh, but have high strength.

2. Description of the Related Art

Many types of conveyor belts are subject to extreme wear leading to rupture or other forms of failure. For example, conveyor belts used in mining operations fail frequently, which can cause an expensive shutdown for several hours. Other conveyor belts lack the strength to be used in extreme conditions. Reinforcing such types of conveyor belts is known, but generally involves the use of reinforcing materials that add to the weight which increases the energy necessary to drive the belt.

### SUMMARY OF THE INVENTION

In accordance with this invention, there is provided a conveyor belt structure comprising a reinforcing fabric base layer, the fabric base comprising a network of high tenacity fibers, and an outer or surface layer of rubber, the basic fabric layer and the outer surface layer being bonded together. The result is a stronger belt that is lighter than other reinforced belt structures. Because of the strength and lightness of weight in the reinforcing base layer, the amount of rubber can be reduced, so that the resulting belt is stronger and lighter and therefore takes less energy to operate. For certain applications, the rubber layer may be bonded to both sides of the fabric base layer.

The conveyor belt structure may also include a thermoplastic bonding layer that bonds to the fabric base to the rubber layer. For certain applications, the bonding layer may be omitted with the rubber bonding directly to the fabric base layer.

The present invention provides a lightweight, but strong conveyor belt structure that is formed from a composite material. The composite material includes a high tenacity fiber containing reinforcing layer and an abrasion resistant rubber surface layer. The composite material for the conveyor belts of this invention is engineered to provide a variety of properties, such as lightness of weight, higher strength, abrasion resistance and/or chemical resistance. Specific properties are dependent on the type of fiber and rubber selected for the specific end use. The lightness of weight without sacrifice of strength leads to operating efficiencies. Preferably the belt is flexible.

### BRIEF DESCRIPTION OF THE DRAWINGS

This invention will become more fully understood and further advantages will become apparent when reference is had to the following detailed description of the preferred embodiments of the invention and the accompanying drawings, in which:

FIG. 1 is a perspective view of a conveyor system having a conveyor belt of this invention;

FIG. 2 is a cross-sectional view (not to scale) of the belt structure along lines 2-2 of FIG. 1; and

FIG. 3 is a perspective view of a portion of the conveyor belt with layers pulled back for illustrative purposes;

### DETAILED DESCRIPTION OF THE INVENTION

The present invention is directed to a conveyor system having conveyor belt structures in which a composite belt structure is formed of 1) a fabric reinforcing layer in turn formed from a network of high tenacity fibers and 2) a surface layer of rubber. The reinforcing layer and the rubber layer are joined in some appropriate manner.

For purposes of the present invention, a fiber is an elongate body the length dimension of which is much greater that the transverse dimensions of width and thickness. Accordingly, the term “fiber” includes monofilament, multifilament, ribbon, strip, staple and other forms of chopped, cut or discontinuous fiber and the like having regular or irregular cross-sections. The term “fiber” includes a plurality of any of the foregoing or a combination thereof. A yarn is a continuous strand comprised of many fibers or filaments.

As used herein, the term “high tenacity fibers” concerns both tenacity and modulus of elasticity. Thus, as used herein “high tenacity fibers” means fibers which have tenacities equal to or greater than about 9 g/d and a tensile modulus of at least 150 g/d. Preferably, these fibers have initial tensile moduli of at least about 150 g/d and energies-to-break of at least about 8 J/g as measured by ASTM D2256. As used herein, the terms “initial tensile modulus”, “tensile modulus” and “modulus” mean the modulus of elasticity as measured by ASTM 2256 for a yarn and by ASTM D638 for an elastomer or matrix material.

Preferably, the high tenacity fibers have tenacities equal to or greater than about 9 g/d, more preferably equal to or greater than about 15 g/d, more preferably equal to or greater than about 20 g/d, and most preferably equal to or greater than about 25 g/d.

The network of fibers used in the composite fabric structure of the present invention may be in the form of woven, knitted or non-woven fabrics formed from high tenacity fibers. The high tenacity fibers may be blended with other fibers of lower tenacity, such as nylon or polyester. Preferably, however, at least 10% by weight of the fibers in the fabric are high tenacity fibers, more preferably at least about 50% by weight of the fibers in the fabric are high tenacity fibers, and still more preferably at least about 75% by weight of the fibers in the fabric are high tenacity fibers. Most preferably all of the fibers in the fabric are high tenacity fibers.

The yarns and fabrics of the invention may be comprised of one or more different high strength fibers. The yarns may be in essentially parallel alignment, or the yarns may be twisted, over-wrapped or entangled. The fabrics of the invention may be woven with yarns having different fibers in the warp and weft directions, or in other directions.

The cross-sections of fibers useful herein may vary widely. They may be circular, flat or oblong in cross-section. They may also be of irregular or regular multi-lobal cross-section having one or more regular or irregular lobes projecting from the linear or longitudinal axis of the fibers. It is preferred that the fibers be of substantially circular, flat or oblong cross-section, most preferably substantially circular.

High tenacity fibers useful in the yarns and fabrics of the invention include highly oriented high molecular weight polyolefin fibers, particularly high modulus polyethylene fibers, aramid fibers, polybenzazole fibers such as polybenzoxazole (PBO) and polybenzothiazole (PBT), high tenacity polyethylene naphthalate fibers, polyvinyl alcohol fibers, polyacrylonitrile fibers, liquid crystal copolyester fibers, basalt or other mineral fibers, as well as rigid rod polymer fibers, and mixtures and blends thereof. Preferred high strength fibers useful in this invention include polyolefin fibers, aramid fibers and polybenzazole fibers, and mixtures and blends thereof. Most preferred are high modulus polyethylene fibers, aramid fibers and polybenzoxazole fibers, and blends and mixtures thereof. The yarns may comprise a single type of fiber or blends of two or more fibers. Additionally, depending on the use of the conveyor, different fibers may be employed in the fiber network.

U.S. Pat. No. 4,457,985 generally discusses such high molecular weight polyethylene and polypropylene fibers, and the disclosure of this patent is hereby incorporated by reference to the extent that it is not inconsistent herewith. In the case of polyethylene, suitable fibers are those of weight average molecular weight of at least about 150,000, preferably at least about one million and more preferably between about two million and about five million. Such high molecular weight polyethylene fibers may be spun in solution (see U.S. Pat. No. 4,137,394 and U.S. Pat. No. 4,356,138), or a filament spun from a solution to form a gel structure (see U.S. Pat. No. 4,413,110, German Off. No. 3,004,699 and GB Patent No. 2051667), or the polyethylene fibers may be produced by a rolling and drawing process (see U.S. Pat. No. 5,702,657). As used herein, the term polyethylene means a predominantly linear polyethylene material that may contain minor amounts of chain branching or comonomers not exceeding about 5 modifying units per 100 main chain carbon atoms, and that may also contain admixed therewith not more than about 50 wt % of one or more polymeric additives such as alkene-1-polymers, in particular low density polyethylene, polypropylene or polybutylene, copolymers containing mono-olefins as primary monomers, oxidized polyolefins, graft polyolefin copolymers and polyoxymethylenes, or low molecular weight additives such as antioxidants, lubricants, ultraviolet screening agents, colorants and the like which are commonly incorporated.

High tenacity polyethylene fibers (also referred to as extended chain or high modulus polyethylene fibers) are preferred and are sold under the trademark SPECTRA® by Honeywell International Inc. of Morristown, N.J., U.S.A.

Depending upon the formation technique, the draw ratio and temperatures, and other conditions, a variety of properties can be imparted to these fibers. The tenacity of the fibers are at least about 9 g/d, preferably at least about 15 g/d, more preferably at least about 20 g/d, and most preferably at least about 25 g/d. Similarly, the initial tensile modulus of the fibers, as measured by an Instron tensile testing machine, is preferably at least about 150 g/d, more preferably at least about 500 g/d, still more preferably at least about 1,000 g/d and most preferably at least about 1,200 g/d. These highest values for initial tensile modulus and tenacity are generally obtainable only by employing solution grown or gel spinning processes. Many of the filaments have melting points higher than the melting point of the polymer from which they were formed. Thus, for example, high molecular weight polyethylene of about 150,000, about one million and about two million molecular weight generally have melting points in the bulk of 138° C. The highly oriented polyethylene filaments made of these materials have melting points of from about 7° C. to about 13° C. higher. Thus, a slight increase in melting point reflects the crystalline perfection and higher crystalline orientation of the filaments as compared to the bulk polymer.

Similarly, highly oriented high molecular weight polypropylene fibers of weight average molecular weight at least about 200,000, preferably at least about one million and more preferably at least about two million may be used. Such extended chain polypropylene may be formed into reasonably well oriented filaments by the techniques prescribed in the various references referred to above, and especially by the technique of U.S. Pat. No. 4,413,110. Since polypropylene is a much less crystalline material than polyethylene and contains pendant methyl groups, tenacity values achievable with polypropylene are generally substantially lower than the corresponding values for polyethylene. Accordingly, a suitable tenacity is preferably at least about 9 g/d, more preferably at least about 11 g/d. The initial tensile modulus for polypropylene is preferably at least about 160 g/d, more preferably at least about 200 g/d. The melting point of the polypropylene is generally raised several degrees by the orientation process, such that the polypropylene filament preferably has a main melting point of at least 168° C., more preferably at least 170° C. The particularly preferred ranges for the above described parameters can advantageously provide improved performance in the final article. Employing fibers having a weight average molecular weight of at least about 200,000 coupled with the preferred ranges for the above-described parameters (modulus and tenacity) can provide advantageously improved performance in the final article.

In the case of aramid fibers, suitable fibers formed from aromatic polyamides are described in U.S. Pat. No. 3,671,542, which is incorporated herein by reference to the extent not inconsistent herewith. Preferred aramid fibers will have a tenacity of at least about 20 g/d, an initial tensile modulus of at least about 400 g/d and an energy-to-break at least about 8 J/g, and particularly preferred aramid fibers will have a tenacity of at least about 20 g/d and an energy-to-break of at least about 20 J/g. Most preferred aramid fibers will have a tenacity of at least about 20 g/d, a modulus of at least about 900 g/d and an energy-to-break of at least about 30 J/g. For example, poly(p-phenylene terephthalamide) filaments which have moderately high moduli and tenacity values are particularly useful in forming ballistic resistant composites. Examples are Kevlar® 29 which has 500 g/d and 22 g/d and Kevlar® 49 which has 1000 g/d and 22 g/d as values of initial tensile modulus and tenacity, respectively. Examples are Twaron® T2000 from Teijin which has a denier of 1000. Other examples are Kevlar® 129 and KM2 which are available in 400, 640 and 840 deniers from du Pont. Aramid fibers from other manufacturers can also be used in this invention. Copolymers of poly(p-phenylene terephthalamide) may also be used, such as co-poly(p-phenylene terephthalamide 3,4′ oxydiphenylene terephthalamide). Also useful in the practice of this invention are poly(m-phenylene isophthalamide) fibers sold by du Pont under the trade name Nomex®.

High molecular weight polyvinyl alcohol (PV-OH) fibers having high tensile modulus are described in U.S. Pat. No. 4,440,711 to Kwon et al., which is hereby incorporated by reference to the extent it is not inconsistent herewith. High molecular weight PV-OH fibers should have a weight average molecular weight of at least about 200,000. Particularly useful PV-OH fibers should have a tensile modulus of at least about 300 g/d, and a tenacity of at least about 10 g/d, preferably at least about 14 g/d and most preferably at least about 17 g/d, and an energy to break of at least about 8 J/g. PV-OH fiber having such properties can be produced, for example, by the process disclosed in U.S. Pat. No. 4,599,267.

In the case of polyacrylonitrile (PAN), the PAN fiber should have a weight average molecular weight of at least about 400,000. Particularly useful PAN fiber should have a tenacity of preferably at least about 10 g/d and an energy to break of at least about 8 J/g. PAN fiber having a molecular weight of at least about 400,000, a tenacity of at least about 15 to 20 g/d and an energy to break of at least about 8 J/g is most useful; and such fibers are disclosed, for example, in U.S. Pat. No. 4,535,027.

Suitable liquid crystal copolyester fibers for the practice of this invention are disclosed, for example, in U.S. Pat. Nos. 3,975,487; 4,118,372 and 4,161,470. Examples are Vectran® fibers from Kuraray.

Preferably the fibers are selected from the group consisting of high modulus polyethylene, aramid, polybenzazole, liquid crystal copolyester, and blends thereof.

Suitable polybenzazole fibers for the practice of this invention are disclosed, for example, in U.S. Pat. Nos. 5,286,833, 5,296,185, 5,356,584, 5,534,205 and 6,040,050. Polybenzazole fibers are available under the designation Zylon® fibers from Toyobo Co.

Rigid rod fibers are disclosed, for example, in U.S. Pat. Nos. 5,674,969, 5,939,553, 5,945,537 and 6,040,478. Such fibers are available under the designation M5® fibers from Magellan Systems International.

The high strength fibers may be utilized in a woven, knitted or non-woven fabric. Woven fabrics of any weave pattern may be employed, such as plain weave, basket weave, twill, satin, three dimensional woven fabrics, and any of their several variations. Plain weave fabrics are preferred and more preferred are plain weave fabrics having an equal warp and weft count.

One preferred material is a woven fabric formed from SPECTRA® polyethylene fibers. In one embodiment, the fabric preferably has between about 15 and about 45 ends per inch (about 5.9 to about 17.7 ends per cm) in both the warp and fill directions, and more preferably between about 17 and about 33 ends per inch (about 6.7 to about 13 ends per cm). The yarns are preferably each between about 650 and about 1200 denier. The result is a woven fabric weighing preferably between about 2 and about 15 ounces per square yard (about 67.8 to about 508.6 g/m²), and more preferably between about 5 and about 11 ounces per square yard (about 169.5 to about 373.0 g/m²). The following table provides fabric constructions that are suitable for use in the present invention. As those skilled in the art will appreciate, the fabric constructions described here are exemplary only and not intended to limit the invention thereto. Each of these uncoated fabrics is available from Hexcel of Anderson, S.C., and is made from SPECTRA® fiber:

| | | Weight | Thickness | Counts | Yarn Denier |
|---|---|---|---|---|---|
| Style | Weave | (Oz/Yd²) | (Inches) | (Ends/Inch) | (Warp/Fill) |
| 902 | Plain | 5.5 | 0.018 | 17 × 17 | 1200/1200 |
| 904 | Plain | 6.3 | 0.017 | 34 × 34 | 650/650 |
| 952 | Plain | 6.0 | 0.017 | 34 × 34 | 650/650 |

As shown in the table, a plain weave fabric having 17 ends per inch of 1200 denier SPECTRA® 900 fiber in both the warp and fill directions weighs only about 5.5 ounces per square yard (about 186.5 g/m²), but has a breaking strength of greater than 800 pounds force per inch (1401 N/cm) in both directions. Other weaves than a plain weave may be employed, such as a basket weave.

As mentioned above, the fabric may also be in the form of a knitted fabric. Knit structures are constructions composed of intermeshing loops, with the four major types being tricot, raschel, net and oriented structures. Due to the nature of the loop structure, knits of the first three categories are not as suitable as they do not take full advantage of the strength of a fiber. Oriented knitted structures, however, use straight inlaid yarns held in place by fine denier knitted stitches. The yarns are absolutely straight without the crimp effect found in woven fabrics due to the interlacing effect on the yarns. These laid in yarns can be oriented in a monoaxial, biaxial or multiaxial direction depending on the engineered requirements. It is preferred that the specific knit equipment used in laying in the load bearing yarns is such that the yarns are not pierced through.

Alternatively, the high strength fabric may be in the form of a non-woven fabric, such as plies of unidirectionally oriented fibers, or fibers which are felted in a random orientation, which are embedded in a suitable resin matrix, as is known in the art. Fabrics formed from unidirectionally oriented fibers typically have one layer of fibers which extend in one direction and a second layer of fibers which extend in a direction 90° from the first fibers. Where the individual plies are unidirectionally oriented fibers, the successive plies are preferably rotated relative to one another, for example at angles of 0°/90° or 0°/45°/90°/45°/0° or at other angles.

The resin matrix for the unidirectionally oriented fiber plies may be formed from a wide variety of elastomeric materials having appropriately low modulus. Preferably, the elastomeric materials used in such matrix possess initial tensile modulus (modulus of elasticity) equal to or less than about 6,000 psi (41.4 MPa) as measured by ASTM D638. More preferably, the elastomer has initial tensile modulus equal to or less than about 2,400 psi (16.5 MPa). Most preferably, the elastomeric material has initial tensile modulus equal to or less than about 1,200 psi (8.23 MPa).

The yarns of the fiber networks useful in the invention may be from about 50 denier to about 3600 denier, preferably from about 200 denier to about 3000 denier and more preferably from about 650 denier to about 1500 denier. Most preferably, the yarns are from about 800 denier to about 1300 denier.

The elastomeric material preferably forms about 1 to about 98 percent by weight, more preferably from about 10 to about 95 percent by weight, of the non-woven fabric. Preferably the resin matrix is flexible which provides a flexible non-woven fabric.

A wide variety of elastomeric materials may be utilized as the resin matrix. For example, any of the following materials may be employed: polybutadiene, polyisoprene, natural rubber, ethylene-propylene copolymers, ethylene-propylene-diene terpolymers, polysulfide polymers, polyurethane elastomers, chlorosulfonated polyethylene, polychloroprene, plasticized polyvinylchloride using dioctyl phthalate or other plasticizers well known in the art, butadiene acrylonitrile elastomers, poly (isobutylene-co-isoprene), polyacrylates, polyesters, polyethers, fluoroelastomers, silicone elastomers, thermoplastic elastomers, and copolymers of ethylene.

Preferred for polyethylene fabrics are block copolymers of conjugated dienes and vinyl aromatic copolymers. Butadiene and isoprene are preferred conjugated diene elastomers. Styrene, vinyl toluene and t-butyl styrene are preferred conjugated aromatic monomers. Block copolymers incorporating polyisoprene may be hydrogenated to produce thermoplastic elastomers having saturated hydrocarbon elastomer segments. The polymers may be simple tri-block copolymers of the type R-(BA)ₓ (x=3-150); wherein A is a block from a polyvinyl aromatic monomer and B is a block from a conjugated diene elastomer.

The elastomeric material may be compounded with fillers such as carbon black, silica, etc and may be extended with oils and vulcanized by sulfur, peroxide, metal oxide or radiation cure systems using methods well known to rubber technologists. Blends of different elastomeric materials may be used together or one or more elastomers may be blended with one or more thermoplastics.

As mentioned above, preferably there is a bonding layer which bonds the fabric base to the rubber layer.

Preferably the bonding layer between the fabric layer and the rubber layer is a thermoplastic material, but thermosetting materials such as epoxies or polyurethanes can also be employed. Preferred thermoplastic bonding materials for the bonding layer are films of olefin polymers or copolymers having a melting point or melting point range less than about 140° C., particularly ethylene polymers and copolymers (e.g., ethylene/propylene copolymers). Melting point is determined, for example, by differential scanning calorimetry (DSC) at a heating rate of 10° C. per minute. The most preferred bonding materials are low density polyethylene (LDPE), ethylene vinyl acetate (EVA) and LDPE/EVA copolymers. The bonding layer can be applied in any suitable form, although a film is particularly preferred. The film can be used to coat and bond to the high performance fabric base described hereinabove, while creating the intermediate bonding layer. EVA bonds particularly well to fabric woven from yarns containing high-strength, high molecular weight polyethylene fibers. The EVA layer acts as a highly satisfactory intermediate bonding layer that has a bonding affinity for both the inner fabric base layer and the outer layer of a rubber compound. While a thickness of up to about 40 mils (about 1 mm) is possible, preferably a thermoplastic film laminate of between about 4 and about 15 mils (about 0.1 to about 0.38 mm) thickness on each side of the fabric provides the most suitable flexible sheet construction. In particular, it has been found that a film thickness on each side of between about 4 mils (0.1 mm) and about 10 mils (0.25 mm) is most desirable when the EVA is used as an intermediate bonding layer. Polyethylene and ethylene vinyl acetate films each weigh about one ounce per mil of thickness per square yard. Thus, a 4 mil laminate on both sides of the fabric sheet adds only about 8 ounces (4 ounces on each side) to the total weight per square yard (about 271 g/m²).

The rubber compound which is attached to the high tenacity fabric base may comprise natural rubber, synthetic rubber, nitrile rubber, and the like, and blends or mixtures of such rubbers. Preferably the rubber compound is selected from the group consisting of natural rubber and styrene butadiene; natural rubber and polybutadiene; and natural rubber, styrene butadiene and polybutadiene. The following table summarizes some of the exemplary compounds useful in the constructions of this invention. Each of these formulations is available from Specialty Tires of America of Indiana, Pa.

| | Natural | Styrene | |
|---|---|---|---|
| Formulation | Rubber | Butadiene | Polybutadiene |
| 2148 | 80% | 20% | 0% |
| 2160 | 66% | 14% | 20% |
| 2141 | 75% | 0% | 25% |
| 2170 | 25% | 35% | 40% |

These rubber compound formulations are obtained as uncured (B-Stage) raw compounds. Once cured, the resulting rubber is relatively hard but is still substantially thin and flexible. The rubber sheet is preferably between about 5 and about 50 mils (about 0.13 to about 1.27 mm) thick, more preferably between about 15 and about 40 mils (about 0.38 to 1 mm) thick, and most preferably about 30 mils (0.76 mm) thick. A release paper may be used to maintain the consistent application (thickness) of the uncured rubber sheet to the coated high strength fabric.

The fabric base layers may be formed in any suitable manner. For example, the thermoplastic film if employed may first be attached to the fabric in accordance with the teachings of U.S. Pat. No. 6,280,546. The final sheet-forming process may be conducted using a three-step process. The first step includes the tacking of the fabric (with coating, if desired, such as an EVA-coated fabric) to a raw rubber compound sheet, with the coated fabric and the rubber sheet being supplied from rolls on a continuous basis. A calendar roll may be used to press the two sheets together to form a lightly covered sheet. As those skilled in the art will appreciate, the process is easily modified where the rubber sheet is desired on both sides of the sheet material.

A suitable machine for tacking the rubber compound sheet to the coated fabric is the Van Vlandrin Silk Calender with a husk soft roll and a steel center roll. Unlike some calendering processes, there is little or no heat applied during the tacking step, to avoid premature curing of the rubber sheet. Once the coated fabric is initially adhered to the rubber sheet, it can be separated therefrom easily until heated and cured. Because the rubber sheet is uncured, i.e., “tacky”, the underlying coated fabric inner layer is important in providing support and underlying structure for the uncured rubber sheet.

One or more composite fabric structure layers may be employed in the structures of this invention. The multiple layer structure may be made of the same or different individual composite layers.

Examples of composite fabric structures useful in this invention are disclosed, for example, in U.S. Pat. No. 7,288,493 the disclosure of which is expressly incorporated herein by reference to the extent not inconsistent herewith.

The conveyor belt structures of this invention may be formed in multiple layers with multiple fibrous network layers being employed. For example, another rubber layer may be attached to the opposite side of the base fabric layer and another bonding layer may connect the fabric base layer with the second rubber layer. This resulting structure also has five layers (rubber layer/bonding layer/fabric layer/bonding layer/rubber layer). Additional layers alternating fabric layers and rubber layers may also be employed, depending on the desired application. For this purpose, however, the rubber layer should preferably be the surface layer of the conveyor belt, the fabric layer serving as a reinforcing or strengthening component.

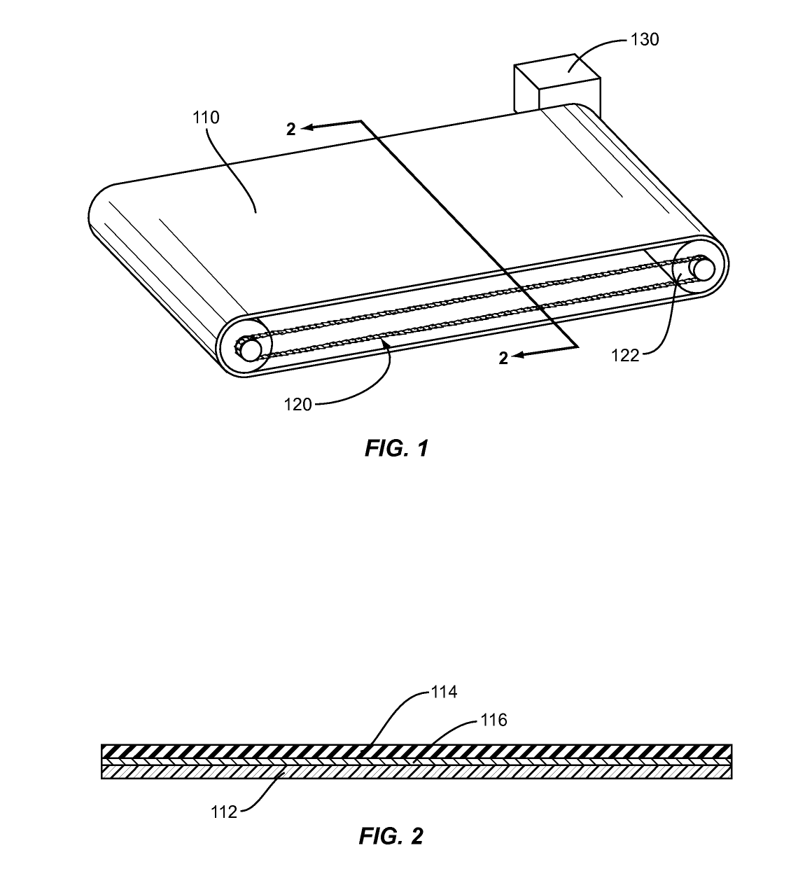

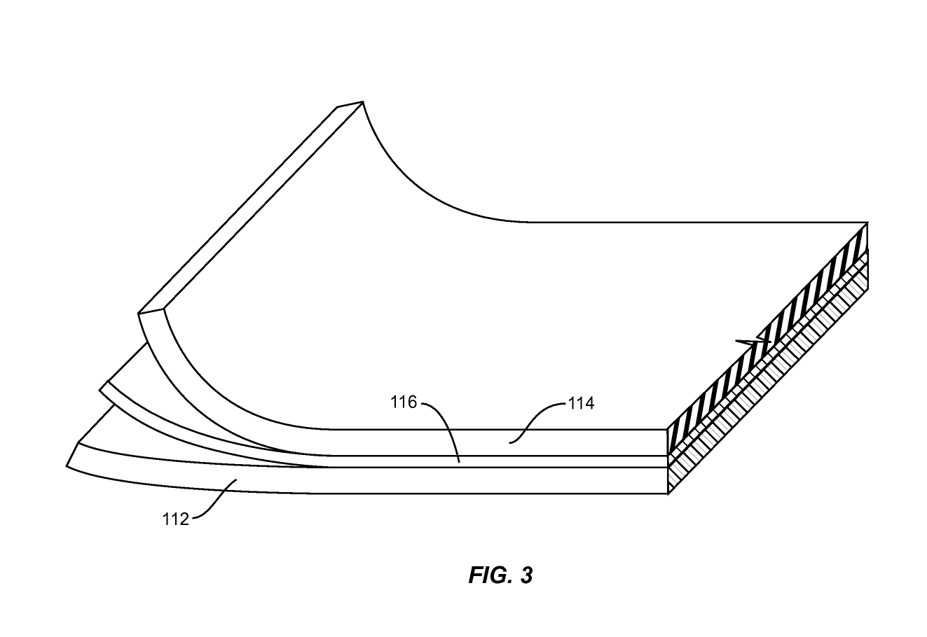

With reference to the drawings, there is shown in FIG. 1 a conveyor system 100 including a conveyor belt 110 arranged around a supporting structure 120 which includes a plurality of wheels 122 over and under which the belt extends. A drive mechanism 130 drives the pulleys (wheels) to move the belt from a loading end to a discharge end.

As best illustrated in FIG. 2 the conveyor belt 110 is formed of a base fabric layer 112 and a rubber layer 114. As described hereinabove, the fabric layer 112 is formed primarily of high tenacity fibers, the rubber layer 114 is a rubber elastomer, and layers 112, 114 are bonded together by a thermoplastic film 116 preferably formed of ethylene vinyl acetate.

The following non-limiting examples are presented to provide a more complete understanding of the invention. The specific techniques, conditions, materials, proportions and reported data set forth to illustrate the principles of the invention are exemplary and should not be construed as limiting the scope of the invention.

### EXAMPLES

### Example 1

A reinforcing fabric was formed from a woven fabric (style 902 from Hexcel) of 1200 denier ultra high molecular weight polyethylene yarn, designated SPECTRA® 900 from Honeywell International Inc., having tensile properties of 28 g/d tenacity and 775 g/d modulus. The fabric was a 17×17 ends/inch (6.7×6.7 ends/cm) plain weave fabric having a thickness of 0.017 inch (0.43 mm).

A bonding layer film formed from an ethylene vinyl acetate polymer (EVA) film having a thickness of 0.003 inch (0.076 mm) was tacked to one side of the fabric. The rubber compound layer was formed from a blend of 80% natural rubber and 20% of styrene butadiene (formulation 2148 from Specialty Tires) and was attached to the bonding layer. The thickness of the rubber layer is 0.0625 inch (1.6 mm).

Lengths of fabric/EVA/rubber were laid out and formed into a roll. The tightly wound roll was wrapped with heat resistant tape and heated in an oven to a temperature of between 210° F. and 300° F. for up to 16 end preferably 270° F. @ 16 hrs. The resulting composite fabric has a thickness of 0.0825 inch (0.21 cm) and a weight of 1.62 Ibs per square yd.

The breaking strengths were 1000 Ibf in the warp direction and 950 Ibf in the fill direction. Measurements were determined in accordance with ASTM D1599.

### Example 2

Example 1 is repeated using as the fibrous layer Kevlar® 29 fabric from Du Pont.

Similar results are noted.

### Example 3

Example 1 is repeated using as the fabric layer a unidirectionally oriented structure of high modulus polyethylene fibers.

Similar results are noted.

### Example 4

Example 1 is repeated using as the fabric layer a fabric formed from PBO fibers.

Similar results are noted.

### Example 5

In some environments, food or tobacco processing for example, thermoplastics such as ethylene vinyl acetate (EVA) cannot be used because of their carcinogenic effects. In such cases, the EVA must be omitted; however, it has been found for these applications that the bonding of the rubber (natural rubber in this example) directly to the base fabric layer is satisfactory and the results about the same.

In each of the examples given above with other fabrics and/or by forming multiple layers, thickness might reach up to 1 inch (2.54 cm), weights up to 20 Ibs/sq. yd, and breaking strengths ranging up to 3500 Ibf in both the warp and fill direction.

Having thus described the invention in rather full detail, it will be understood that such detail need not be strictly adhered to but that further changes and modifications may suggest themselves to one skilled in the art, all falling within the scope of the invention as defined by the subjoined claims.

What is claimed is:

1. A conveyor belt structure comprising
a) at least one surface layer formed of a rubber composition; and
b) a reinforcing base layer formed by a fibrous network having at least 10% high tenacity fibers; and
c) each surface layer bonded to one of the surfaces of the base layer.

2. The conveyor belt structure of claim 1 wherein the high tenacity fibers have a tenacity of at least about 25 grams per denier and a tensile modulus of at least 1200 grams per denier.

3. The conveyor belt structure of claim 1 wherein the high tenacity fibers are selected from the group consisting of high modulus polyethylene, aramid, polybenzazole, liquid crystal copolyester, and blends thereof.

4. The conveyor belt structure of claim 1 wherein the fibrous network includes at least 50% high tenacity fibers.

5. The conveyor belt structure of claim 1 wherein the fibrous network includes at least 75% of high tenacity fibers.

6. The conveyor belt structure of claim 1 wherein the fabric base comprises a woven fabric.

7. The conveyor belt structure of claim 1 wherein the rubber comprises a natural rubber.

8. The conveyor belt structure of claim 1 wherein the rubber comprises a composition selected from the group consisting of natural rubber and styrene butadiene; natural rubber and polybutadiene; and natural rubber, styrene butadiene and polybutadiene.

9. The conveyor belt structure of claim 1 wherein the surface layer is bonded to the reinforcing base layer by a thermoplastic material.

10. The conveyor belt structure of claim 9 wherein the high tenacity fibers are high molecular weight polyethylene fibers and the rubber comprises a blend of 80% natural rubber and 20% styrene butadiene.

11. The conveyor belt structure of claim 1 and further including a bonding layer between the base layer and each surface layer.

12. The conveyor belt structure of claim 11 wherein the bonding layer comprises ethylene vinyl acetate.

13. The conveyor belt structure according to claim 1 wherein a surface layer formed of a rubber composition is bonded to each surface of the reinforcing base layer by a bonding layer.

14. The conveyor belt structure according to claim 1 wherein the structure comprises multiple reinforcing base layers separated by at least one layer of the rubber composition.

15. A conveyor system comprising
a) a conveyor belt arranged around a support structure and driven by a drive mechanism;
b) a drive mechanism connected to and driving the support system for moving the conveyor belt between a loading end and a discharge end;
c) the conveyor belt comprising
i) at least one surface layer formed of a rubber composition;
ii) a reinforcing base layer formed by a fibrous network having at least 25% high tenacity fibers; and
iii) each surface layer bonded to one of the surfaces of the base layer.

16. The conveyor system of claim 15 wherein the high tenacity fibers have a tenacity of at least about 25 grams per denier and a tensile modulus of at least 1200 grams per denier.

17. The conveyor system of claim 15 wherein the high tenacity fibers are selected from the group consisting of high modulus polyethylene, aramid, polybenzazole, liquid crystal copolyester, and blends thereof.

18. The conveyor system of claim 15 wherein the fibrous network includes at least 50% high tenacity fibers

19. The conveyor system of claim 15 wherein the fibrous network includes at least 75% of high tenacity fibers.

20. The conveyor system of claim 15 wherein the high tenacity fibers comprise ultra high molecular weight polyethylene fibers.

21. The conveyor system of claim 15 wherein the fabric base comprises a woven fabric.

22. The conveyor system of claim 15 wherein the rubber comprises a natural rubber.

23. The conveyor system of claim 15 wherein the rubber comprises a composition selected from the group consisting of natural rubber and styrene butadiene; natural rubber and poly butadiene; and natural rubber, styrene butadiene and poly butadiene.

24. The conveyor system of claim 15 wherein the surface layer is bonded to the reinforcing base layer by a thermoplastic material.

25. The conveyor system of claim 24 wherein the fabric base comprises high molecular weight polyethylene fibers and said rubber comprises natural rubber.

26. The conveyor belt structure of claim 25 and further including a bonding layer between the base layer and each surface layer.

27. The conveyor system of claim 26 wherein the bonding layer comprises ethylene vinyl acetate.

28. The conveyor system according to claim 15 wherein a surface layer formed of a rubber composition is bonded to each surface of the reinforcing base layer by a bonding layer.

29. The conveyor system according to claim 15 wherein the conveyor belt comprises multiple reinforcing base layers separated by at least one layer of the rubber composition.
